(19) United States
(12) Patent Application Publication
(10) Pub. No.: US 2004/0190786 A1
(43) Pub. Date: Sep. 30, 2004

(54) Method of image enhancement for an imaging apparatus

(76) Inventor: Khageshwar Thakur, Lexington, KY (US)

Correspondence Address: Elizabeth C. Jacobs, Lexmark International, Inc., Intellectual Property Law Dept., 740 West New Circle Road, Bldg. 082, Lexington, KY, 40550, US

(21) Appl. No.: 10/395,754

(22) Filed: Mar. 24, 2003

(51) Int. Cl. G06K 9/40

(52) U.S. Cl. 382/254

(57) ABSTRACT

An image enhancement method includes steps of defining a mask for use with first image input data provided at a first imaging resolution; providing second image input data at a second imaging resolution having a first portion and a second portion; applying the mask to the first portion of the second image input data to form a corresponding first portion of second image output data having a first plurality of output pixels; and deriving from the second portion of the second image input data a corresponding second portion of the second image output data having a second plurality of output pixels, wherein each output pixel of the corresponding second portion of second image output data is based on at least one respective output pixel of the first portion of second image output data.

### BACKGROUND OF THE INVENTION

1. Field of the invention.

The present invention relates to imaging, and, more particularly, to a method of image enhancement for an imaging apparatus.

2. Description of the related art.

It is well known in digital imaging to perform image enhancement to enhance spatial features, wherein an input image is convolved using an enhancement matrix, or also commonly known as an enhancement mask. In general, the size of the mask and the value of its elements determine the degree and nature of the enhancement. For example, a mask could be a 2 pixel by 4 pixel area, a 4 pixel by 4 pixel area, a 10 pixel by 10 pixel area, etc. In general, an averaging mask will tend to blur an image, and a bigger mask will tend to blur more than a smaller mask.

Often, it is desirable to enhance by sharpening certain portions of an image, while enhancing by dulling other parts of the image. For example, it may be desirable to sharpen the edges of the face or eyes, while blurring facial blemishes. In frequency space, such features can be represented by low frequency (wide in space) and high frequency (narrow in space), respectively. For example, blemishes on the face, or noise from scanning or photography, are some of the undesired elements in household imagery represented by high frequency signals. Sizes of these elements are typically 1/100^{th} of an inch or less, and can be suppressed by blurring the image through a mask of similar size. Other low frequency elements of a size more than 1/100^{th} of an inch are usually much desired ones. These elements can be boosted by sharpening the image through a mask of twice this size. A favorable result can be obtained by boosting, i.e., sharpening, low frequency portions of an image and suppressing, i.e., blurring, high frequency portions of an image.

In addition, the size of the mask has been made to be dependent on the image resolution. In other words, in prior solutions the size of the mask increases as image resolution increases. Generally, the size of the mask needed is proportional to the image resolution in each dimension, e.g., vertically and horizontally. One disadvantage of increasing mask size, however, is that larger masks require more processing time than smaller masks, when using the same computational unit.

What is needed in the art is a method of image enhancement for an imaging apparatus, wherein the size of an enhancement mask need not be increased as resolution is increased.

### SUMMARY OF THE INVENTION

The present invention provides image enhancement for an imaging apparatus, wherein the size of an enhancement mask need not be increased as resolution is increased.

The invention comprises, in one form thereof, an image enhancement method, including the steps of defining a first imaging resolution and a second imaging resolution, the second imaging resolution being higher than the first imaging resolution; defining a mask for use with first image input data provided at the first imaging resolution; providing second image input data at the second imaging resolution, the second input image data having a first portion and a second portion, the first portion being interleaved with the second portion; applying the mask to the first portion of the second image input data to form a corresponding first portion of second image output data having a first plurality of output pixels; and deriving from the second portion of the second image input data a corresponding second portion of the second image output data having a second plurality of output pixels, wherein each output pixel of the corresponding second portion of second image output data is based on at least one respective output pixel of the first portion of second image output data.

An advantage of the present invention is that image enhancement of an image can be preformed wherein the size of the enhancement mask need not be increased as resolution is increased.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a diagrammatic depiction of a system embodying the present invention;

FIG. 2 is a block diagram showing exemplary processing units used in association with the present invention;

FIG. 3 is a general flowchart of an image enhancement method of the present invention; and

FIGS. 4 and 5 are graphs showing the results of using the method of the present invention for low resolution image data and high resolution image data, respectively.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

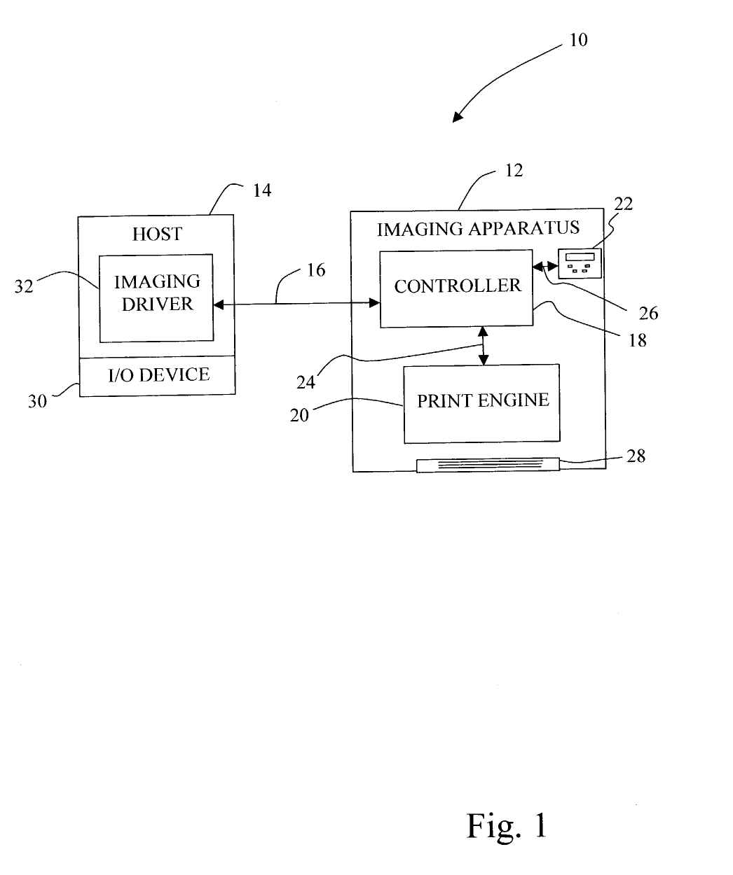

Referring now to the drawings, and particularly to FIG. 1, there is shown a diagrammatic depiction of a system 10 embodying the present invention. System 10 includes an imaging apparatus 12 and a host 14. Imaging apparatus 12 communicates with host 14 via a communications link 16.

Imaging apparatus 12 can be, for example, an ink jet printer and/or copier, or an electrophotographic printer and/or copier. Imaging apparatus 12 includes a controller 18, a print engine 20 and a user interface 22.

Controller 18 includes a processor unit and associated memory, and may be formed as an Application Specific Integrated Circuit (ASIC). Controller 18 communicates with print engine 20 via a communications link 24. Controller 18 communicates with user interface 22 via a communications link 26.

In the context of the examples for imaging apparatus 12 given above, print engine 20 can be, for example, an ink jet print engine or an electrophotographic print engine, configured for forming an image on a print medium 28, such as a sheet of paper, transparency or fabric.

Host 14 may be, for example, a personal computer including an input/output (I/O) device 30, such as keyboard and display monitor. Host 14 further includes a processor, input/output (I/O) interfaces, memory, such as RAM, ROM, NVRAM, and a mass data storage device, such as a hard drive, CD-ROM and/or DVD units. During operation, host 14 includes in its memory a software program including program instructions that function as an imaging driver 32, e.g., printer driver software, for imaging apparatus 12. Imaging driver 32 is in communication with controller 18 of imaging apparatus 12 via communications link 16. Imaging driver 32 facilitates communication between imaging apparatus 12 and host 14, and may provide formatted print data to imaging apparatus 12, and more particularly, to print engine 20. Alternatively, however, all or a portion of imaging driver 32 may be located in controller 18 of imaging apparatus 12.

Communications link 16 may be established by a direct cable connection, wireless connection or by a network connection such as for example an Ethernet local area network (LAN). Communications links 24 and 26 may be established, for example, by using standard electrical cabling or bus structures, or by wireless connection.

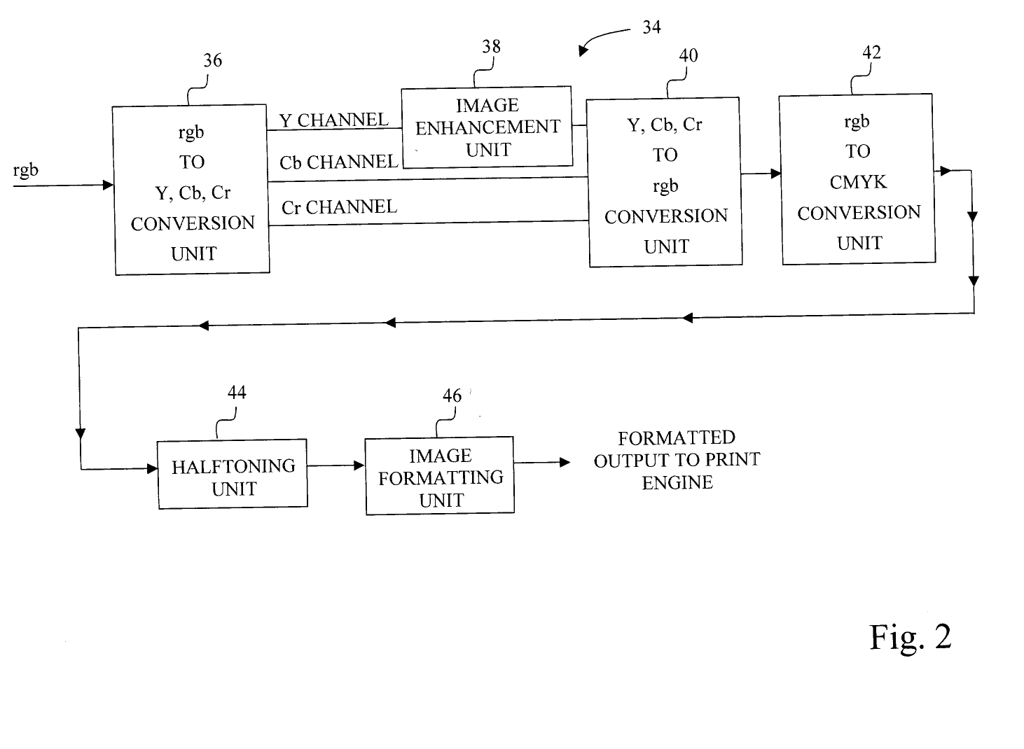

FIG. 2 is a block diagram showing exemplary processing units 34 used in association with the present invention. Processing units 34 may be in the form of software or firmware. Processing units 34 may be located in imaging driver 32 of host 14, in controller 18 of imaging apparatus 12, or a portion of processing units 34 may be located in each of imaging driver 32 and controller 18. As shown in this example, processing units 34 include an rgb-to-Y,Cb,Cr conversion unit 36, an imaging enhancement unit 38, a Y,Cb,Cr-to-rgb conversion unit 40, an rgb-to-CMYK conversion unit 42, a halftoning unit 44 and an image formatting unit 46. In general, each of the conversion units 36, 40 and 42 take input signals from one color space domain and convert them into output signals of another color space domain for each image generation. As is well known in the art, color conversion takes place to convert from a light-generating color space domain of, for example, a color display monitor that utilizes primary colors red (r), green (g) and blue (b) to a light-reflective color space domain of, for example, a color printer that utilizes colors, such as for example, cyan (C), magenta (M), yellow (Y) and black (K).

As shown, rgb data, such as the output from an application executed on host 14, is supplied to rgb-to-Y,Cb,Cr conversion unit 36, which in turn converts the rgb input data into Y,Cb,Cr data. Rgb-to-Y,Cb,Cr conversion unit 36 outputs the Y,Cb,Cr data three output channels, respectively: a Y channel, a Cb channel and a Cr channel. Using the intermediary rgb-to-Y,Cb,Cr conversion during rgb to CMYK conversion advantageously permits implementation of the image enhancement method of the present invention on a single channel, e.g., the Y Channel (luminance channel), of the input color signals, as opposed to multiple channels. However, one skilled in the art will recognize that the present invention may be adapted to operate on each of multiple input channels, such as for example, r, g and b color data, or C, M, Y and K color data, although such an approach would require significantly more processing in handling each of the multiple channels.

Once image enhancement is performed by image enhancement unit 38, the Y (enhanced),Cb,Cr data is converted back to rgb data by Y,Cb,Cr-to-rgb conversion unit 40. Y,Cb,Cr-to-rgb conversion unit 40 produces an rgb output which is processed by rgb-to-CMYK conversion unit 42 to generate CMYK continuous tone data. The CMYK continuous tone data is then processed by halftoning unit 44 to generate CMYK halftoned image data. The CMYK halftoned image data is then processed via image formatter 46 to produce bitmapped image data at a desired format and resolution for use by print engine 20.

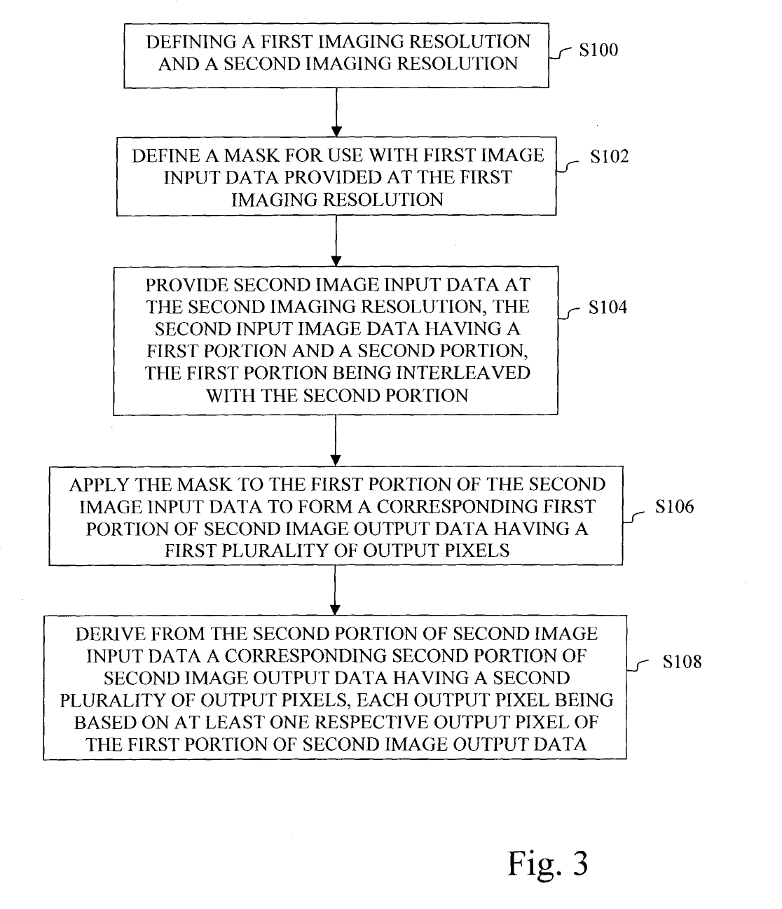

FIG. 3 is a general flowchart of an image enhancement method of the present invention, which may be implemented as instructions executed by a processing unit, such as for example, image enhancement unit 38. The present invention advantageously uses the same image enhancement mask used to enhance a relatively lower resolution image to enhance a first portion of relatively higher resolution image, and then enhances a remaining portion of the higher resolution image by derivation based on the outputs of the first portion. Thus, a single image enhancement mask can be used for multiple imaging resolutions.

As used herein, unless otherwise indicated, the terms “first” and “second” are names used merely for convenience to distinguish between two items having somewhat similar properties.

At step S100, a first imaging resolution and a second imaging resolution are defined. In this example, the second imaging resolution is considered to be higher than the first imaging resolution. For example, the first resolution could be 600 dots per inch (DPI) and the second resolution could be 1200 DPI.

At step S102, a mask is defined for use with first image input data provided at the first imaging resolution. In this example, an enhancement mask is built that is suitable for a low-resolution image, e.g., 600 DPI. For simplicity and ease of understanding, the following discussion of the example started above at step S100 will be limited to one dimension, although one skilled in the art will recognize that the present invention can be applied to two dimensions as well.

For low resolution, suppose I is a low-resolution image given by I={I₀, I₁, I₂, I₃, I₄}, M is a mask given by M={M₀, M₁, M₂} and O is output given by O={O₀, O₁, O₂, O₃, O₄}. Then, the output pixel O₂ is given by O₂=I₁M₀+I₂M₁+I₃M₂. Other output pixels are calculated in a similar fashion. The border region represented by pixels I₀ and I₄ represent special cases, wherein O₀=I₀M₀+I₀M₁+I₁M₂ and O₄=I₃M₀+I₄M₁+I₄M₂.

At step S104, there is provided second image input data at the second imaging resolution. The second input image data has a first portion and a second portion, with the first portion being interleaved with the second portion. For example, along a particular scanline formed of a plurality of input pixels, in general, the first portion may represent a repeating pattern of pixel groups, wherein the group size is 1 to N pixels, and the second portion includes pixels located between said repeating pattern of pixel groups. As a more specific example, the first portion could correspond to the even numbered input pixels and the second portion could correspond to the odd input pixels.

At step S106, the mask is applied to the first portion of the second image input data to form a corresponding first portion of second image output data having a first plurality of output pixels. For example, the same enhancement mask used for the low-resolution image, e.g., 600 DPI, is applied to a high-resolution image, e.g. 1200 DPI, but some pixels are skipped during the application along a particular scanline. Thus, in this example, the same enhancement mask that can be applied to a low resolution image is applied to an image of two times higher resolution. Calculations for an output pixel O₄ is shown as follows. For high resolution, suppose I is a high-resolution image given by I={I₀, I₁, I₂, I₃, I₄, I₅, I₆, I₇, I₈, I₉}, and O is output given by O={O₀, O₁, O₂, O₃, O₄, O₅, O₆, O₇, O₈, O₉}. Then, the output pixel O₄ is given by O₄=I₂M₀+I₄M₁+I₆M₂. Notice here that pixels 3 and 5 were not considered. Other even-numbered pixels are also calculated in a similar fashion. For example, the output pixel O₆ is given by O₆=I₄M₀+I₆M₁+I₈M₂.

At step S108, from the second portion of the second image input data there is derived a corresponding second portion of the second image output data having a second plurality of output pixels. Each output pixel of the corresponding second portion of second image output data is based on at least one respective output pixel of the first portion of second image output data. Thus, in step S108, the effect of masking is spread to the skipped pixels from its neighbors which were processed during the masking step S106. In the example started above, the second portion is derived by calculating the odd-numbered output pixels by finding the change in input and output of a neighboring pixel and applying the same change to odd-numbered pixels. For example, output O₁ is calculated as O₁=I₁+(O₀−I₀); output O₃ is calculated as O₃=I₃+(O₂-I₂); output O₅is calculated as O₅=I₅+(O₄−I₄); output O₇ is calculated as O₇=I₇+(O₆−I₆), and output O₉ is calculated as O₉=I₉+(O₈−I₈). I₀ represents a border condition, which is a special case, and the corresponding output is determined by: O₀=I₀M₀+I₀M₁+I₂M₂.

The enhancement method of the present invention may be represented mathematically as follows.

In general, if s is the size of mask designed for (lower) resolution n₁ and used at (higher) resolution n₂ then output pixels for the higher resolution are given by (with appropriate boundary correction):

$${O}_{i} = {\sum }_{k = 0}^{S - 1} {M}_{k} {I}_{i + ( k - s / 2 ) \times n}$$

where n=n₂/n₁ and i is an integral multiple of n,

for example,

$$n = \frac{600 \text{dpi}}{300 \text{dpi}} = 2 ; n = \frac{900 \text{dpi}}{300 \text{dpi}} = 3 , \text{etc.}$$

and,

Oᵢ₊ⱼ=Iᵢ₊ⱼ+(Oᵢ−Iᵢ)

where j=1, 2, 3 . . . (n−1).

Those skilled in the art will recognize that the above formula may be extended to two dimensions.

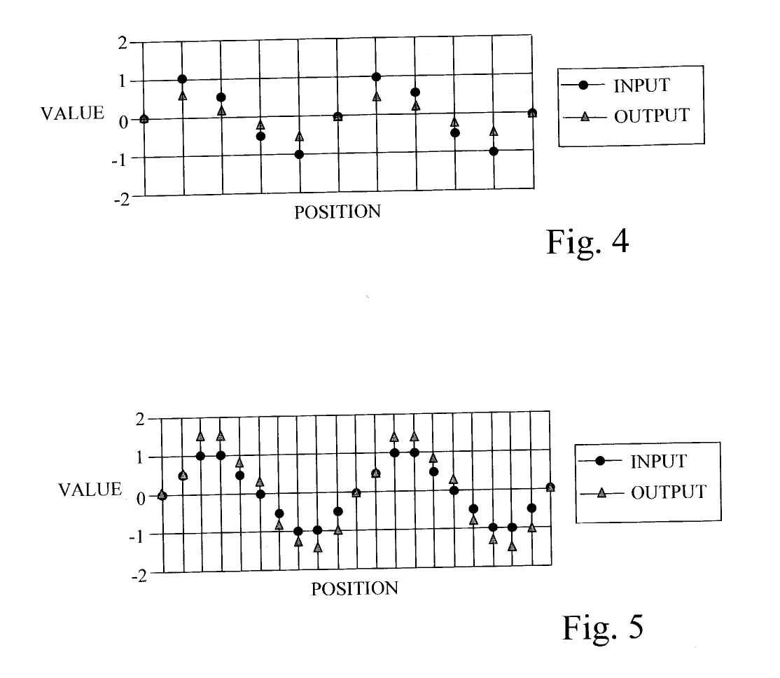

The results of using the method of the present invention can be visualized with reference to FIGS. 4 and 5. Again for simplicity and ease of understanding, in this next example the method of the present invention is applied one-dimensionally to input data that generally approximates a sinusoidal waveform. In this example, a five member mask is used, [M₀, M₁, M₂, M₃, M₄], and more specifically, [−⅕, ⅕, 1, ⅕, −⅕], which is intended to blur high frequency elements and sharpen low frequency elements. The results are shown for low resolution (FIG. 4) and high resolution (FIG. 5).

In practice, the method of the present invention is applied to the entire image. Further, the method of the present invention preserves the amount of image data, i.e., there is no pixel addition or depletion. Still further, in using the method of the present invention it takes almost the same time processing at all resolutions without compromising quality.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An image enhancement method, comprising the steps of:
defining a first imaging resolution and a second imaging resolution, said second imaging resolution being higher than said first imaging resolution;
defining a mask for use with first image input data provided at said first imaging resolution;
providing second image input data at said second imaging resolution, said second input image data having a first portion and a second portion, said first portion being interleaved with said second portion;
applying said mask to said first portion of said second image input data to form a corresponding first portion of second image output data having a first plurality of output pixels; and
deriving from said second portion of said second image input data a corresponding second portion of said second image output data having a second plurality of output pixels, wherein each output pixel of said corresponding second portion of second image output data is based on at least one respective output pixel of said first portion of second image output data.

2. The method of claim 1, wherein said first portion is a repeating pattern of pixel groups, and said second portion includes pixels located between said repeating pattern of pixel groups.

3. The method of claim 1, wherein said first portion and said second portion are located along a scanline of pixels, said first portion including one of odd numbered pixels and even numbered pixels, and said second portion including an other of said odd numbered pixels and said even numbered pixels.

4. The method of claim 1, wherein in said deriving step, an output pixel of said corresponding second portion of said second image output data is derived by calculating a change between an input value of a neighboring pixel of said first portion of said second image input data and an output value of said neighboring pixel of said first portion of said second image input data, said output value of said neighboring pixel being determined during the step of applying said mask.

5. The method of claim 1, wherein said method is performed on a single channel of data.

6. A system including a processing unit, said processing unit executing instructions for performing an image enhancement method, comprising the steps of:
defining a first imaging resolution and a second imaging resolution, said second imaging resolution being higher than said first imaging resolution;
defining a mask for use with first image input data provided at said first imaging resolution;
providing second image input data at said second imaging resolution, said second input image data having a first portion and a second portion, said first portion being interleaved with said second portion;
applying said mask to said first portion of said second image input data to form a corresponding first portion of second image output data having a first plurality of output pixels; and
deriving from said second portion of said second image input data a corresponding second portion of said second image output data having a second plurality of output pixels, wherein each output pixel of said corresponding second portion of second image output data is based on at least one respective output pixel of said first portion of second image output data.

7. The system of claim 6, wherein said first portion is a repeating pattern of pixel groups, and said second portion includes pixels located between said repeating pattern of pixel groups.

8. The system of claim 6, wherein said first portion and said second portion are located along a scanline of pixels, said first portion including one of odd numbered pixels and even numbered pixels, and said second portion including an other of said odd numbered pixels and said even numbered pixels.

9. The system of claim 6, wherein in said deriving step, an output pixel of said corresponding second portion of said second image output data is derived by calculating a change between an input value of a neighboring pixel of said first portion of said second image input data and an output value of said neighboring pixel of said first portion of said second image input data, said output value of said neighboring pixel being determined during the step of applying said mask.

10. The system of claim 6, wherein said method is performed on a single channel of data.
